(19) United States
(12) Patent Application Publication
(10) Pub. No.: US 2013/0246009 A1
(43) Pub. Date: Sep. 19, 2013

(54) Device for Capturing Information for Virtual Deployment and Method Associated with it

(71) Applicant: Eneko SOLABERRIETA MENDEZ, LEIOA (Vizcaya) (ES)

(72) Inventor: Eneko SOLABERRIETA MENDEZ, LEIOA (Vizcaya) (ES)

(73) Assignee: Universidad Del Pais Vasco - Euskal Herriko Unibersitatea, Leioa (Vizcaya) (ES)

(21) Appl. No.: 13/422,095

(22) Filed: Mar. 16, 2012

(51) Int. Cl. G06F 17/50; G06G 7/60

(52) U.S. Cl. 703/1; 703/11

(57) ABSTRACT

The invention relates to a device for capturing information for virtual deployment and method associated with it, comprising a main body which allows collecting information by information collection means to perform computer-aided simulation, where said main body comprises a first part which allows coupling to the element to be captured, and where said main body further comprises a second part which allows the device to be the target of the information collection means which, in conjunction with other information collection means positioned on the element to be captured, allow obtaining optimal reference coordinates for a computer-aided system.

### OBJECT OF THE INVENTION

The present invention has an application in the technical field of dentistry and more specifically in the branch of the prosthodontics, and it relates to a device for capturing information for virtual deployment of all the elements necessary for the simulation of the teeth of a patient and the articulation thereof, the purpose of which is to optimize the methods carried out on widely used artificial dental models which facilitate the study of the masticatory apparatus of a patient external to the teeth in order to thus perform excessively invasive operations for the patient or those operations which cannot be carried out in the mouth of the patient.

More specifically, the object of the invention is a device for capturing information for virtual deployment which allows optimizing the method for the placement of the models of the teeth of the patient such that the task of the relative positioning of said models does not require of elements such as physical articulators or face-bows for placing said model, but said placement is done by means of virtual simulation in dental CAD/CAMs or computer-aided three-dimensional models of the teeth, where said optimal placement is possible due to the use of this device which allows taking direct references from the patient for the virtual positioning of models.

### BACKGROUND OF THE INVENTION

Currently, one of the needs that can be seen in the field of dentistry is the performance of some procedures and their testing outside the mouth of the patient for technical reasons, for the sake of comfort or for the prediction of the results, so it is necessary to use a mechanical replica of the masticatory apparatus of the patient outside the mouth of the patient.

Plaster models of the teeth, registrations taken in wax or another material for taking the reference of the relative position between top and bottom teeth, a face-bow or device for physical capture for taking positioning references and a physical articulator for positioning the dental models in the original position of the mouth of the patient and being able to simulate masticatory function and jaw movements derived from the actual articulation simulating the mouth of the patient, are normally used to obtain the mechanical model of the teeth of the patient in order to perform different operations, such as designing a dental prosthesis, for example.

In dental laboratories, in the typical case of designing a dental prosthesis, work has traditionally been done following conventional methodology, so measurements of the patient are taken by means of a physical face-bow for placing the upper dental arch or top teeth with respect to the cranial system, said record is transferred to the physical articulator for simulation, the plaster models are positioned in the corresponding position in the physical articulator and the prostheses are designed by hand, such that consistent with the method, the results obtained are results that can be transferred to the occlusion or jaw closure of the patient with few closure surface adjustments of the simulation models.

However, several years ago CAD/CAM dental systems consisting of three-dimensional computer-aided designs of dental models were introduced, which has entailed an improvement in several aspects of design, such as the application of new materials to said designs, the automation or reduction of manual labor or higher profitability with better control quality.

Nonetheless, there are aspects which must be improved in these CAD/CAM systems, so as of today research continues and there is progression in the development and improvement of these systems which entail a cost reduction and offer a better result, favoring dentistry and prosthodontics operations and eliminating difficulties therein.

Parallel to these mentioned CAD/CAM systems, several years ago the first virtual articulators were developed: the “DentCam” virtual articulator by Kordass and the Szentpétery virtual articulator (neither of which can be found on the market today) such that costs were to be reduced by no longer using physical articulators as its functions could be carried out by means of computer simulation, by means of the virtual deployment of all the elements of the simulation, to simulate the movements of the human jaw, being able to record them, move the dental occlusal or closure surfaces (i.e., the surfaces of the teeth contacting one another when closing the teeth or establishing occlusion) digitized with respect to one another, according to those movements and correcting the digitized occlusal surfaces, allowing movements without collisions, where the information obtained is used to subsequently correct dental closure surfaces of crowns and bridges manufactured with a CAD/CAM system.

This development of the CAD/CAM systems for the simulation of models in terms of novelties provided by new articulators has entailed an advance and brought with it advantages in qualitative aspects, in that tasks are performed in a more simple, reliable and precise manner, but they have brought with them a considerable increase in costs to the extent that taking information by means of scanning the models to simulate required the positioning of said models in the physical articulator previously, so it is necessary to mount it manually and later scan it.

Several virtual articulators within CAD/CAM systems, such as Amman Girbach, Zfx, 3Shape, SmartOptics, EXOCAD and Zirkonzahn, which all require mounting models in a physical articulator and once placed, scanning the models mounted in that position as described above, were presented in the International Dental Show held in March 2011 in Cologne.

Patent applications have been filed for the aforementioned ZirkonZahn and SmartOptics systems, currently being processed, with numbers EP-2229913-A1 and DE-102008060504-A1, said registrations comprising inventions requiring the use of both the mentioned physical face-bow for taking references between upper and lower models and for being able to mount said plaster models in a physical articulator for scanning in that position, to finally place it in the virtual articulator.

The mentioned system proposed by ZirkonZahn requires introducing the physical articulator with the mounted models in the scanner for positioning both models in the virtual articulator, and the system proposed by SmartOptics requires positioning the models on the upper and lower plates of the articulator, and they are placed in that position in the scanner which has and recognizes the same geometry as the physical articulator, so it can be said that it does not do away with the physical articulator since it is integrated in the scanner.

The Arcus Digma, Zebris and AXIOQUICK devices capable of recording three-dimensional jaw movements by means of ultrasounds were furthermore presented during the 2011 International Dental Show, but said devices do not allow directly relating the information records of the mouth of the patient with virtual articulators like the object of the invention does, and furthermore the use of these devices entails a considerable economic investment.

Therefore, according to the foregoing, the inventions up until now known in the state of the art carry out the function of the object of invention, but in no case do they comprise a device capable of directly transferring the placement of the models of the teeth of the patient to the virtual articulator directly.

### DESCRIPTION OF THE INVENTION

The present invention relates to a device for capturing information for virtual deployment which overcomes the drawbacks indicated above as it presents a body comprising a first part supported by the dental occlusion of the patient, from where there extends a fork-like projection covering at least part of the facial perimeter of the teeth to allow positioning the adhesives targeting the relevant recording of information through information recording means, such as for example scanner or digital photography camera with software, which in conjunction with other additional facial references taken in the same pass of the means for recording information, allow transferring the information necessary for the suitable positioning of the top teeth in the relevant virtual articulator, such that they allow the virtual deployment of the elements of the simulation without needing the physical articulator or the physical face-bow, because the placement on the virtual articulator is done without prior actual positioning of the models on a physical articulator as has been done up until now.

Specifically, the device for capturing information for virtual deployment proposed by the invention comprises a main body which allows collecting information by information collection means to perform computer-aided simulation, where said main body can have a first part which allows its coupling to the element to be captured, and where said main body can further comprise a second part which allows the device to be the target of the information collection means which, in conjunction with other information collection means positioned on the element to be captured, allow obtaining optimal reference coordinates for a computer-aided system.

The possibility that the first part and the second part are connected by connection means is contemplated, such that the entire device is a rigid part and such that by means of supporting one of the parts, the other one is in a projecting arrangement.

The possibility that the first part is a tray which allows the placement of the teeth of the patient is contemplated, such that it can be supported with the mouth of the patient and such that said tray can house the model of the teeth for the information collection processes.

The possibility that the second part comprises a circumferential sector is contemplated, such that it facilitates the coupling of the information collection means to said second part covering at least part of the facial perimeter.

The possibility that the reference coordinates resulting from the comparison between the information obtained from the device in the patient and the information obtained from the device with the model of the teeth comprise at least one Cartesian coordinate axis is contemplated.

The possibility that the circumferential sector comprises faces to facilitate the placement of the information collection means for collecting information is contemplated.

The possibility that the tray comprises a housing which allows the coupling of a mold in which to fit the teeth of the patient or to fit an artificial model corresponding to said teeth is contemplated.

A second aspect of the invention relates to a method for capturing information by means of the use of the device for capturing for virtual deployment, whereby information is collected by information collection means to perform computer-aided simulation, comprising the steps of:

(i) determining the information collection points inherent to the element to be captured, said points being the points of the face and of the head in general, and the top teeth of a patient being the element to be captured;

(ii) coupling the device to the element to be captured, i.e., the top teeth of the patient, by means of the coupling of the tray to said top teeth of the patient, such that the information taken is information about the top teeth of the patient;

(iii) collecting combined information from the information collection means corresponding both to the device and to the points of the head of step (i) by means of taking information from the device mounted on the top teeth of the patient;

(iv) generating reference coordinates according to the information obtained, taking as the origin one of the measured targets;

(v) collecting information corresponding to the element to be captured by means of scanning or taking information from the device with the upper dental model mounted thereon;

(vi) virtually relating the reference coordinates with the information from the preceding step about the captured element;

(vii) matching up said reference coordinates with the captured element, such that the virtual top teeth are positioned with respect to the reference coordinates;

(viii) placing the captured element in the position resulting from the match established in the preceding step, allowing, where the top teeth of the patient are the captured element, said virtual top teeth to be placed in the virtual articulator given the reference of the skull;

(ix) repeating steps (i) to (v) with another element belonging to the same set of elements to be captured, i.e., the bottom teeth of the patient, such that the coordinates of the axis of the jaw are obtained;

(x) using information from steps (i) to (v) and generating a new coordinate system; and

(xi) positioning the virtual top teeth;

In other words, a new kinematic intercondylar axis is calculated, and by using a third point already captured in steps (i) to (v), a new coordinate system is generated, for which purpose this system is generated in the file where the model of the virtual top teeth is saved, or there are targets of the placement of the upper model in said file in order to place this new coordinate system with the upper model.

The possibility that the at least three information collection points in step (i) are adhered on the surface corresponding to the skull of the patient is further contemplated because the surface to which they are adhered is planar and prepared for such purpose.

The possibility that the device is coupled to the top teeth of the patient through a mold in step (ii) is further contemplated, such that the information of the top teeth of the patient is recorded, where said mold is formed by a paste that hardens with the negative shape of the top teeth of the patient.

The possibility that the element from which the information collection means collect information in step (iii) is a model of the top teeth recreated from the mold is further contemplated.

In another embodiment of the present invention, the possibility that the element from which the information collection means collect information in step (iii) is the top teeth of the patient directly is further contemplated.

The possibility that the information collection means act only on the device, with the model of the top teeth connected to said device through the mold in step (v) is further contemplated, such that when dumping all the information for virtual simulation, on one hand there is an actual measurement of step (iii) measured on the top teeth of the patient, and by means of step (v) the measurement of the model of the top teeth model is obtained, so the possibility that the relative position of the top teeth with respect to the skull of the patient, which allows transferring to the computer-aided design system, is obtained by means of comparing the recorded information of the device coupled to the mouth of the patient with the recorded information of the device coupled to the model in step (vii) is further contemplated.

The possibility that the virtual model is placed in a virtual articulator of a computer-aided design system in step (viii) is contemplated.

The possibility that in step (ix) information about the two elements is recorded in a combined manner is contemplated, such that information about the upper model and about the lower model is recorded in a combined manner, one being in contact with the other.

Finally, the possibility that both models positioned with respect to one another are placed in the virtual articulator of the computer-aided design system is contemplated.

Therefore, according to the described invention the device proposed by the invention constitutes an advance in the methods for capturing information for the simulation of masticatory processes used up until now and solves in a fully satisfactory manner the drawbacks described above in terms of replacing the use bulky and expensive face-bows and also bulky and expensive physical articulators, doing so in a simple manner, with the subsequent improvements of the operations for capturing information about the patient and simulation of the masticatory processes, and with the subsequent cost reduction due to the optimization and efficiency of the process, all through a simple design, and not entailing any difficulties in use and not requiring the skill of a trained operator.

### DESCRIPTION OF THE DRAWINGS

To complement the description being made and for the purpose of aiding to better understand the features of the invention according to a preferred practical embodiment thereof, a set of drawings is attached as an integral part of said description in which the following has been depicted with an illustrative and non-limiting character:

FIG. 1 shows a schematic view of the scanner and of the face of the patient with three adhered marks representing the adhesives targets for the scanner, a detail of the teeth of the patient showing the dental occlusion such that it supports the device object of the invention of which the reference from which the projection extends can be seen, in which projection another arrangement of adhesives can also be seen.

FIG. 2 shows a detailed view of the model of the teeth of a patient placed on the reference model and the projection with the adhesives of the scanner.

FIG. 3 shows a detailed view of the result of the use of the device with the scanner, which are the upper model of the teeth positioned with respect to a coordinate axis representing the cranial reference of the patient.

FIG. 4 shows a schematic view of the virtual model of the top teeth placed on the virtual articulator.

FIG. 5 shows a diagram of the method for capturing information by means of the device, where it can be seen how:

the points of the patient for collecting information are determined;

the device is coupled to the top teeth of the patient;

the information about the top teeth of the patient is collected by means of the device;

a coordinate system is generated;

information about the upper model coupled to the device is taken;

the upper model is related to the coordinate system of the patient;

information about the top and bottom teeth is recorded in a combined manner and a new coordinate system is obtained;

the coordinate system of the upper model previously obtained is matched with the new coordinate system obtained for the bottom teeth of the patient.

FIG. 6 shows the recording of the information about the occlusion or closure position between upper and lower models, with the information collection means and the means used for recording the occlusive area of the teeth of both models for external scanner use.

FIG. 7 shows the virtual arrangement of the recorded information shown in FIG. 6.

FIG. 8 shows the device of the invention coupled to the bottom teeth of the patient in a specific position for external scanner use.

### PREFERRED EMBODIMENT OF THE INVENTION

In view of the indicated figures, it can be observed how in one of the possible embodiments of the invention, the device for capturing information for virtual deployment proposed by the invention is preferably a face-bow preferably consisting of a main body (1) which is formed by a first part (2) which is preferably a tray (6) acting as a supporting means for supporting the device preferably by means of the occlusion of the teeth, such that said teeth preferably leave an imprint on a mold preferably made of alginate placed in said tray (6), and a second part (4) which is preferably a circumferential sector (7) and is connected to the first part (2) by connection means (3) which are preferably a connection rod, where said circumferential sector (7) preferably having a semicircular shape, once the patient bites the tray (6), said circumferential sector (7) is in a projecting arrangement because the tray (6) is placed at one end of said rod, and said circumferential sector (7) is placed at the other end of the same connection rod being outside the mouth and in front of the nose, as can be seen in FIG. 1.

In order to take information about the device placed in the patient, an external scanner is preferably used, such that there are information collection means (11) which are preferably stickers acting as a target for scanning the points to which they are adhered, which are preferably three points of the head of the patient and several points of the circumferential sector (7) which is designed for containing said stickers since it is preferably formed by a series of almost planar faces (9) forming an arc, such that the external scanner collects information about both the head of the patient and about the circumferential sector (7) which is connected to the tray (6), and hence to the teeth of the patient, which allows obtaining reference coordinates (5) that are preferably Cartesian coordinate axes x, y, z that are transferred to a computer-aided design system, as can be seen in FIGS. 1, 2 and 5.

As can be seen in FIG. 2, after generating a model of the top teeth which is preferably done in plaster, the latter is placed in a housing (10) of the tray (6) and adjusted to it preferably by means of using the mold, such that it is in the position closest to that which the teeth of the patient were fixed during the first collection of information.

In addition to the first collection of information performed with the device placed in the top teeth of the patient, a second collection of information is performed by means of the external scanning of the device coupled to the model of the top teeth in the aforementioned manner, such that the model is loaded in the aided design system and can be compared and matched up with the reference coordinate system (5) previously obtained by preferably performing a mathematical analysis for the best possible positioning of the model of the virtual top teeth (which is called “best fit analysis”) in the reference coordinates (5) preferably having coordinate axes (8), as can be seen in FIGS. 2, 3 and 5.

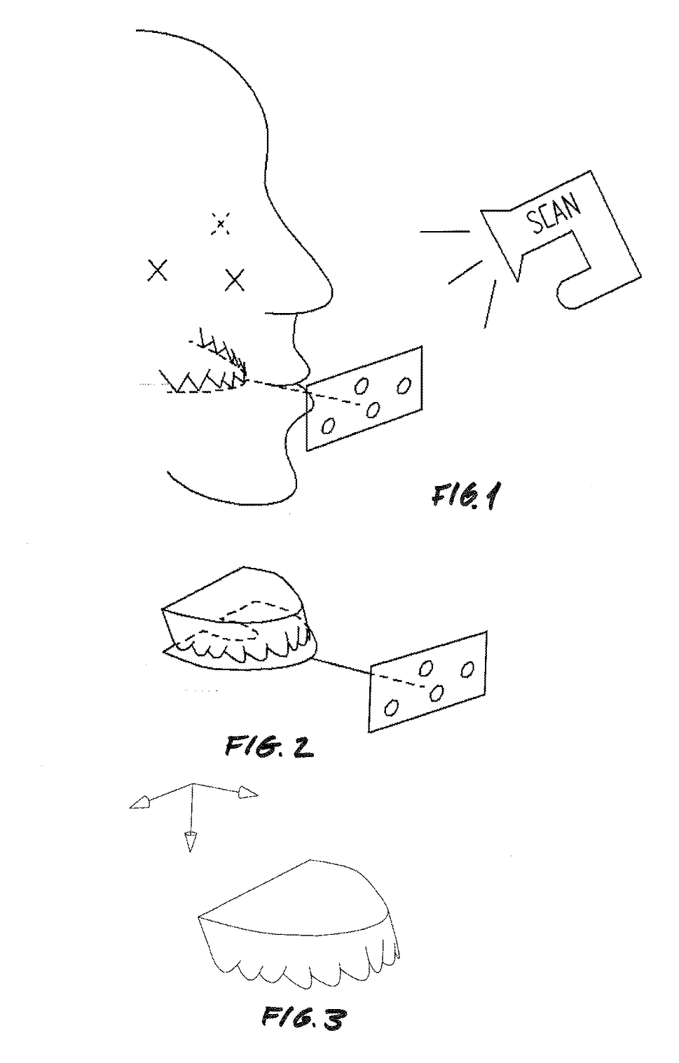

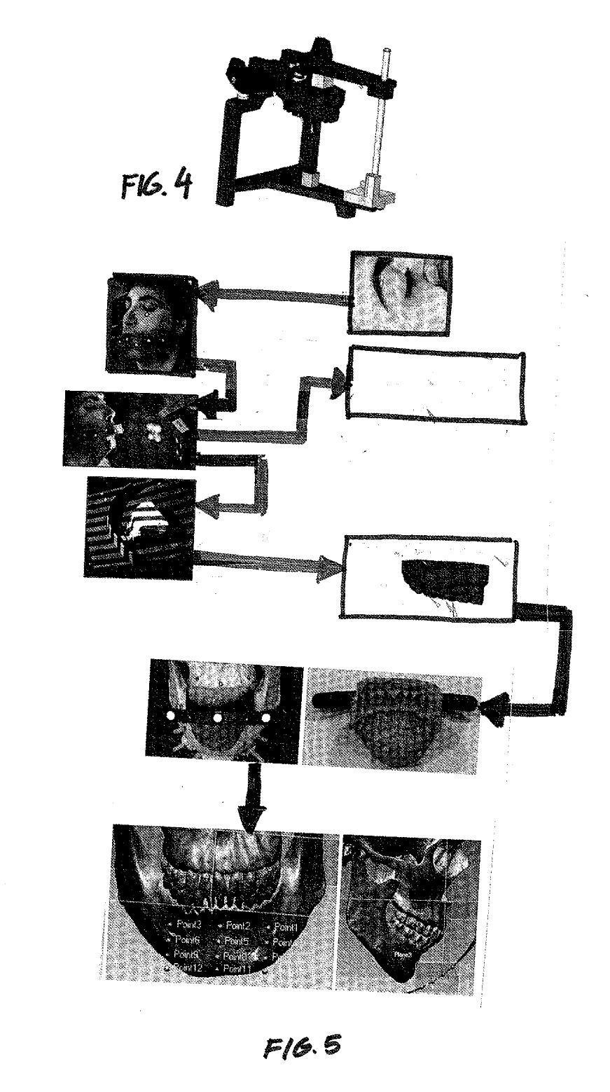

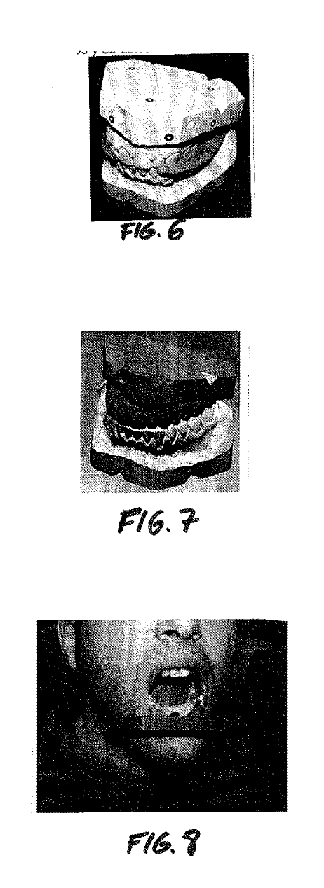

Once the virtual model of the top teeth is thus placed in the cranial system of the patient as can be seen in FIGS. 4 and 5, such that with these elements for the virtual simulation duly placed and related, it is possible to perform operations on the simulated teeth of the patient outside his/her mouth.

By means of coupling the information collection means (11) in the models of the mounted top and bottom teeth simulating the dental occlusion and by means of recording said position with a mold as can be seen in FIG. 6, a second collection of information about the bottom teeth of the patient is performed to obtain the coordinates of the intercondylar axis, i.e., about the axis which, connected to the skull, forms the articulation of the jaw, so once said new coordinates are obtained, the previously obtained coordinates are matched up such that the virtual simulation of the complete set of teeth of the patient is obtained as can be seen in FIG. 7.

In a second possible embodiment of the invention, the information collection means (11) are preferably an internal scanner whereby it is not necessary to generate the model of the top teeth, so: only the first part (2) of the device is scanned in contrast with what is observed in FIG. 2, where said first part (2) has an imprint thereof after establishing the occlusion thereon, so that the best possible positioning of the top teeth of the patient can be obtained by means of mathematical analysis, matching up the geometries of the top teeth (scanned separately) with said imprint generated by the teeth, as can be seen in the last image of FIG. 5.

In the same manner, the device is used on the bottom teeth of the patient without using the model of the bottom teeth, such that the information about the device and about the patient is collected from several positions of the bottom teeth with respect to the top teeth, such that relevant information for obtaining the virtual simulation is obtained, as can be seen in FIG. 8 and in the last image of FIG. 5.

In another preferred embodiment of the invention, the information collection means (11) are preferably a digital photography camera.

1. Device for capturing information for virtual deployment, comprising a main body (1) which allows collecting information by information collection means (11) to perform computer-aided simulation, characterized in that said main body (1) comprises a first part (2) which allows coupling to the element to be captured, and where said main body (1) further comprises a second part (4) which allows the device to be the target of the information collection means which, in conjunction with other information collection means positioned on the element to be captured, allow obtaining optimal reference coordinates (5) for a computer-aided system.

2. Device for capturing information for virtual deployment according to claim 1, characterized in that the first part (2) and the second part (4) are connected by connection means (3).

3. Device for capturing information for virtual deployment according to claim 1, characterized in that the first part (2) is a tray (6) which allows the placement of one of the two sets of teeth.

4. Device for capturing information for virtual deployment according to claim 1, characterized in that the second part (4) comprises a circumferential sector (7).

5. Device for capturing information for virtual deployment according to claim 1, characterized in that the reference coordinates (5) comprise at least one coordinate axis (8).

6. Device for capturing information for virtual deployment according to claim 4, characterized in that the circumferential sector (7) comprises faces (9) to facilitate the placement of the information collection means (11).

7. Device for capturing information for virtual deployment according to claim 1, characterized in that the tray (6) comprises a housing (10) which allows the coupling of a mold to fit the teeth of a patient or an artificial model corresponding to said teeth.

8. Method for capturing information by means of the device for capturing for virtual deployment whereby information is collected by information collection means (11) to perform computer-aided simulation, characterized in that it comprises the steps of:
(i) determining the information collection points inherent to the element to be captured;
(ii) coupling the device to the element to be captured;
(iii) collecting information from the information collection means corresponding to both the device and the element to be captured in a combined manner;
(iv) generating reference coordinates (5) according to the information obtained;
(v) collecting information corresponding to the element to be captured;
(vi) virtually relating the reference coordinates (5) with the information from the preceding step about the captured element;
(vii) matching up said reference coordinates (5) with the captured element;
(viii) placing the captured element in the position resulting from the match established in the preceding step;
(ix) repeating steps (i) to (v) with another element belonging to the same set of elements to be captured;
(x) using information from steps (i) to (v) and generating a new coordinate system;
(xi) positioning the virtual top teeth;

9. Method for capturing information by means of the device for capturing information for virtual deployment according to claim 8, characterized in that in step (i), the at least three information collection points are adhered on the surface corresponding to the skull of the patient.

10. Method for capturing information by means of the device for capturing information for virtual deployment according to claim 8, characterized in that in step (ii) the device is coupled to the teeth of the patient through a mold, such that the information about one of the sets of teeth of the patient is recorded.

11. Method for capturing information by means of the device for capturing information for virtual deployment according to claim 8, characterized in that in step (iii) the element from which the information collection means (11) collect information is one of the sets of teeth of the patient.

12. Method for capturing information by means of the device for capturing information for virtual deployment according to claim 8, characterized in that in step (iii) the element from which the information collection means (11) collect information is a model of the teeth recreated from the mold.

13. Method for capturing information by means of the device for capturing information for virtual deployment according to claim 8, characterized in that in step (v) the information collection means (11) act only on the device with the model of the teeth connected to it through the mold.

14. Method for capturing information by means of the device for capturing information for virtual deployment according to claim 8, characterized in that in step (vii) the relative position of the teeth with respect to the skull of the patient is obtained by means of comparing the recorded information of the device coupled to the mouth of the patient with the recorded information of the device coupled to the model, which allows transferring said positioned model to the computer-aided design system.

15. Method for capturing information by means of the device for capturing information for virtual deployment according to claim 8, characterized in that in step (viii) the virtual model is located in a virtual articulator of the computer-aided design system.

16. Method for capturing information by means of the device for capturing information for virtual deployment according to claim 8, characterized in that in step (ix) information about the two elements is recorded jointly.

17. Method for capturing information by means of the device for capturing information for virtual deployment according to claim 8, characterized in that both models positioned with respect to one another are located in the virtual articulator of the computer-aided design system.
